(19) United States
(12) Patent Application Publication
(10) Pub. No.: US 2023/0137327 A1
(43) Pub. Date: May 4, 2023

(54) Spinning Top Centrifuge

(71) Applicant: XplorStem LLC, San Diego, CA (US)

(72) Inventors: Vicki MEADOWS, San Diego, CA (US); Robert MEADOWS, San Diego, CA (US); Erika BARNER, El Cajon, CA (US)

(73) Assignee: XplorStem LLC, San Diego, CA (US)

(21) Appl. No.: 17/910,669

(22) PCT Filed: Mar. 9, 2021
(86) PCT No.: PCT/US21/21568

§ 371 Date: Sep. 9, 2022

Related U.S. Application Data
(60) Provisional application No. 62/988,125, filed on Mar. 11, 2020.

(51) Int. Cl. B04B 9/08; B04B 5/04

(52) U.S. Cl. CPC B04B 9/08; B04B 5/0414

(57) ABSTRACT

This invention concerns a centrifugal device that houses adapters for commercial or scientific samples (or tubes containing such samples) and is manually operated. In preferred embodiments, the adapter is housed in a modern version of a spinning top that is powered by repetitive pumping motion using a helical rod and clutch mechanism.

### GOVERNMENT FUNDING

This invention was made at least in part with U.S. government support under grant no. 1914134 awarded by the National Science Foundation. As such, the U.S. government may have certain rights in this invention.

### BACKGROUND OF THE INVENTION

Manually powered centrifuges have been developed for multiple purposes ranging from analysis of blood samples in remote areas to removing water from vegetables such as lettuce. Manually powered centrifuges include the salad spinner, a “paperfuge”, and various manual devices using a turn-gear mechanism.

Salad spinners operate by a series of gears that are located in the lid of the device. The lid is attached to a colander and the colander rotates within a bowl as the gears are moved by a pumping or reciprocating motion. The salad spinner has been adapted to separate scientific samples by affixing plates and tubes to the salad spinner colander through mechanical means such as putties and zip ties. A “Handyfuge” is available commercially. Here, adapters for scientific samples have been attached to the lid of a salad spinner and the lid-adapter combination is placed with the salad spinner bowl. In all cases, the lid is affixed to the colander or samples and suspended over the bowl.

The paperfuge is designed based upon the childhood toy, the whirligig. Capillary tubes are attached to concentric circles of paper that have holes through which a string is passed such that the string can be pumped resulting in the circles spinning at high speed. This design is suitable for very small sample volumes of a few microliters. Samples cannot be removed from the capillary tubes without losing the centrifugal separation, so it is only appropriate for cases where a visualization of the separation is sufficient.

Human-powered centrifuges that employ gear mechanisms were first reported around 1900 and have been used to separate cream in milk and scientific samples. Such a device is typically attached to a table or comparable surface through a vice and consists of a spindle with affixed test tube holders that are rotated by hand-turning a series of gears. When the handle of the device is used to rotate the gears, the test tubes spin forming a fan where the test tubes would be the blades of the fan. The test tube holders can house larger sample volumes, for example, 15 milliliters (mL). The samples rotate freely with no protection provided to the user beyond her/his ability to keep a distance from the exposed, rotating tubes. It resembles a fan without a protective grating and with test tubes affixed to the blades. This latter model is the current state-of-the-art for manually powered centrifuges in science education.

### Definitions

Before describing the invention in detail, several terms used in the context of the present invention will be defined. In addition to these terms, others are defined elsewhere in the specification, as necessary. Unless otherwise expressly defined herein, terms of art used in this specification will have their art-recognized meanings.

As used herein, the singular forms “a”, “an”, and “the” include plural references unless the context clearly dictates otherwise.

The term “about” refers to approximately a +/−10% variation from the stated value. It is to be understood that such a variation is always included in any given value provided herein, whether or not it is specifically referred to.

An “adapter” refers to an article or device that connects one article to another, for example, a device that allows analysis of scientific samples by centrifugation when placed within a spinning object.

An article is “fixed” when one or more physical structures, adhesives, or the like is/are used to secure it to or with another article. Depending on the context, fixation can be permanent or temporary.

The term “functional association”, “functionally associate”, and the like refer to bringing two or more articles into association such that together they function as intended.

A “patentable” article, device, machine, composition, or process according to the invention means that the subject matter at issue satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically excludes the unpatentable embodiment(s). Also, the claims appended hereto are to be interpreted both to provide the broadest reasonable scope, as well as to preserve their validity. Furthermore, if one or more of the statutory requirements for patentability are amended or if the standards change for assessing whether a particular statutory requirement for patentability is satisfied from the time this application is filed or issues as a patent to a time the validity of one or more of the appended claims is questioned, the claims are to be interpreted in a way that (1) preserves their validity and (2) provides the broadest reasonable interpretation under the circumstances.

A “plurality” means more than one.

The terms “removable”, “removably attached”, and the like means that one article, when attached to another, can be removed without damage such that the removed article can be reused if desired, including being attached (or fixed) again to the same or a different article.

The term “tabletop” refers to a flat, smooth, level surface suitable for setting in motion a manually powered centrifuge device according to the invention. Such surfaces include table or desktops, scientific workbenches, and the like. In addition, any other suitable surface, for example, a concrete floor, that can be so used to practice the invention will also be understood to be a “tabletop” in this context.

### SUMMARY OF THE INVENTION

The object of the invention is to provide a centrifugal device that spins through manual pumping or reciprocating action of a suitable clutch-containing drive system where the samples are housed in the bowl of the device. In current preferred embodiments, the invention must be safe for children to operate independently and must exert sufficient centrifugal force to separate scientific samples common in K-12 education laboratories. In these embodiments, the interior of the device is hollow and accommodates an adapter (or insert or rotor) that houses scientific samples, preferably in removable, capable tubes (e.g., microcentrifuge tubes such as 1.5 mL Eppendorf tubes). Unlike centrifugal devices based upon salad spinners, a device of the invention does not require suspending the samples from the lid of the unit or attachment to the colander through putty and zip ties. The spinnable centrifuge assembly (or any suitable manually powered rotable assembly now known or later developed and suitable for use in the context of the invention) does not require attachment to a table or surface to operate. It can be spun freely on any (preferably flat, level, and smooth) surface. However, the device is not limited to spinning freely on any surface. In some embodiments, the device may spin on an adapter that is attached to a surface. The devices of the invention may be used in the analysis of industrial or scientific samples and, in particularly preferred embodiments, for the purpose of science education. In some currently preferred embodiments, the manually powered centrifugal device of the invention resembles a familiar toy in appearance, making it appealing to children.

In some preferred embodiments, the manually powered centrifugal device of the invention is comprised of a cylindrical rotatable assembly having a chamber or bowl that has an affixed insert (or adapter or rotor) designed to house scientific samples, although embodiments without a bowl are envisioned as are embodiments in which the chamber or bowl is adapted to receive a sample (or tube) holder, for example, a removable rotor that includes cavities for holding sample-containing tubes. In some of these embodiments, the drive mechanism beneath the chamber includes an attached inverse cone that is the point of contact between the manually spinnable centrifuge assembly and the surface on which it spins. The spinnable centrifuge assembly has a spindle rod perpendicular and affixed to the base of the rotatable chamber. The top of the rod includes the bottom of a clutch mechanism, which preferably is a series of raised bumps on the surface of the rod. The rod is hollow and houses a flat helical spiral that rotates the centrifuge assembly by an up and down pumping motion relative to the surface where the inverse cone is resting. On top of the rod is a lid that encloses an upper radial paddle with the same series of raised bumps. The radial paddle has a slit where the helical spindle passes and moves up and down within the clutch lid during the pumping motion, resulting in continual spinning of the centrifuge assembly. On top of the helical spindle is a handle and on the bottom is a protrusion that keeps the spindle from passing through the radial paddle and clutch mechanism.

In one embodiment of the invention, the insert (or adapter or rotor) is designed to house microcentrifuge test tubes that hold up to 1.5 ml of sample. The insert (or adapter or rotor) is affixed to the base of the rotatable chamber and can hold 2 or more sample-containing tubes. In some preferred embodiments, the insert (or adapter or rotor) is configured to hold an even number of samples (e.g., 2, 4, 6, 8, 10, or more), with half of the samples being located 180 degrees from the other half to provide balance during rotation. In other embodiments, the insert (or adapter or rotor) is configured to hold samples spaced by 90, 60, or 45 degrees.

### BRIEF DESCRIPTION OF THE DRAWINGS

The present invention is further detailed with respect to the following drawings. The drawings are not intended to limit the scope of the present invention but rather to illustrate certain attributes. Unless otherwise indicated, it is understood that the drawings are not to scale, as they are intended merely to facilitate understanding of the invention as opposed to specific dimensions, etc. In the drawings, like numbers in two or more drawings represent the same elements.

FIGS. 1 and 2 are side views of a representative embodiment of the invention shown without the helical twisted rod that drives the clutch mechanism. The device shown in FIG. 2 is rotated 90 degrees in relation to FIG. 2.

FIG. 3 is a close-up of a representative embodiment of the spinner that is affixed to the bottom of the bowl.

FIG. 4 is a close-up of the alignment rod that aligns the center of the cone that forms the spinner with the center of the centrifuge bowl.

FIG. 5 is a close-up of a representative embodiment of the clutch assembly showing the top of the spindle rod forming one part of the clutch, a floating radial plate forming a second part of the clutch, and a lid.

FIG. 6 depicts a representative embodiment of the helical twisted flat rod passing through the clutch mechanism.

FIG. 7 depicts an embodiment of the helical rod showing a handle on the top of the helical rod and a disk affixed to the bottom of the rod that keeps it from passing through the clutch.

FIG. 8 depicts one embodiment of the insert (or adapter or rotor) that holds two microcentrifuge tubes.

FIG. 9 depicts an embodiment of a safety lid designed to cover the samples while the centrifuge is in use.

FIGS. 10 and 11 depict perspective views of a fully assembled representative embodiment of the invention. The view shown in FIG. 11 is a perspective view looking down on the device, while the perspective view shown in FIG. 10 is from below,

FIG. 12 depicts two views (12A, 12B) of a microcentrifuge tube with trichloroacetic acid precipitated trypsin protein before (12A) and after (12B) centrifugation with the device.

Features and advantages of the invention will be apparent from the following detailed description, drawings, and appended claims.

### DETAILED DESCRIPTION OF THE INVENTION

The present invention is a manually powered centrifugal device that spins through manual pumping or reciprocating action. In one embodiment, the invention resembles a toy top and can be used as a science teaching tool. This embodiment of the invention is fully depicted in FIGS. 1-12.

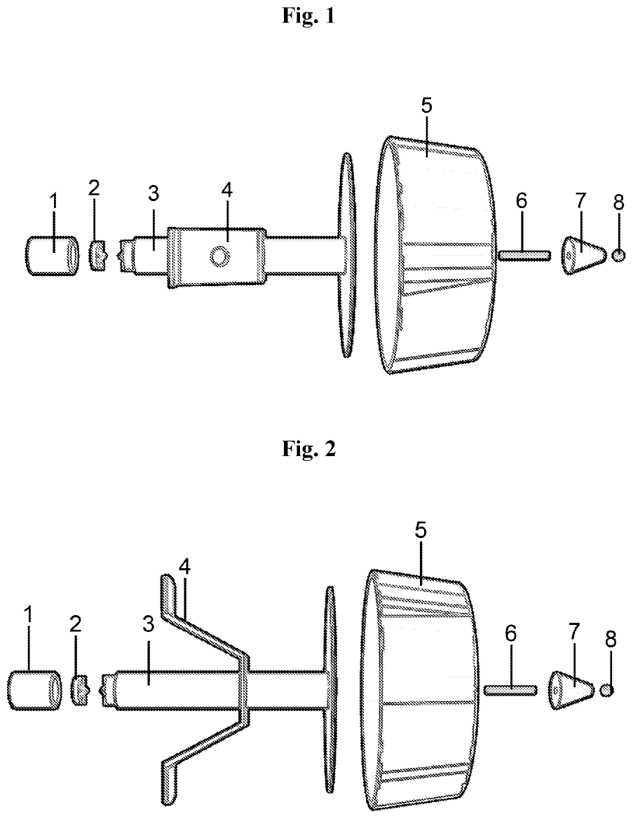

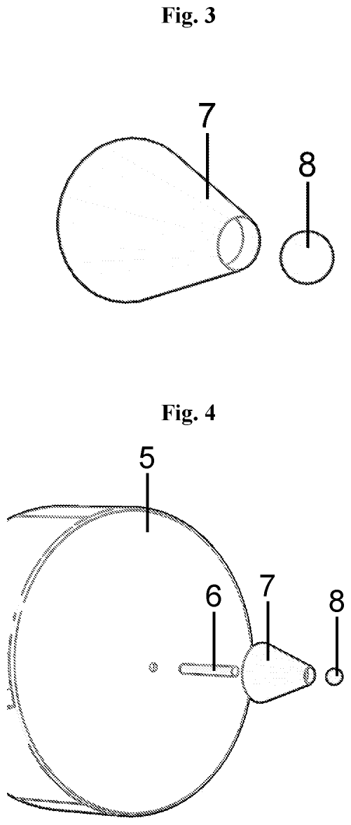

FIGS. 1 and 2 depict the device at 90-degree angles. The center spindle rod (3) is hollow and accommodates the helical rod (9) depicted in FIG. 4. The helical rod (9) moves up and down (reciprocates) during the pumping action that drives rotation of the centrifuge as detailed below. The spindle rod (3) has a disk located at one end that is the same diameter as the inside of the bowl (5) and is affixed to the inside at its base (5). As detailed in FIGS. 3 and 4, a cone (7) with a cylindrical indent at its apex has a 5 mm glass bead (8) affixed within this cylinder to minimize friction between the device and the surface upon which the device rests during the spinning process. FIG. 4 details that the cone, or spinner (7), is affixed to the bottom of the bowl (5) and centered using an alignment rod (6). One end of the alignment rod (6) inserts into a hole in the center of the bottom of the bowl (5) and the other into the base of the cone (7) as show in FIG. 4. The alignment rod (6) also protrudes into a matching hole at the bowl-side of the spindle rod (3) to further ensure its alignment with the bowl (5) and spinner (7). Proper alignment is critical for the final device to be balanced and spin evenly and uninterrupted.

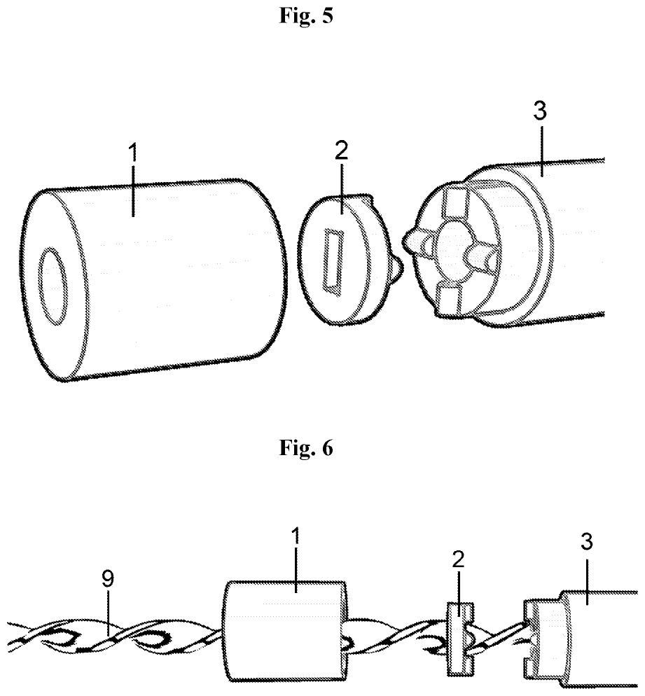

The other end of the spindle rod (3) is part of the clutch mechanism. A close-up of the clutch-side of the spindle rod is depicted in FIG. 5. In this embodiment, the clutch includes four arc-shaped bumps on the clutch-side of the spindle rod (3). The spindle rod (3) has a lip at its end to accommodate the clutch lid (1). Inside of the clutch is a radial disk (2) with 4 arc-shaped bumps that are a mirror image of the tip of the spindle rod (3). The radial disk (2) has a slit through which the helical rod (9) passes as depicted in FIGS. 5 and 6. To assemble the clutch mechanism, the helical rod (9) is passed through the slit of the radial disk (2) and into the spindle rod (3) as depicted in FIG. 6. The gear lid (1) is affixed to the top of the spindle rod (3) to create an enclosed chamber where the radial disk (2) moves up and down during the pumping motion of the helical rod (9) within the assembled clutch. Contact between the radial disk (2) and top of the spindle rod (3) within the clutch when the helical rod (9) is pushed down results in the centrifuge assembly spinning. When the helical rod (9) is lifted, the clutch disengages and the centrifuge assembly continues to spin. Other configurations in which rotation is imparted during both the down and up strokes of the helical rod can also be adapted for use with the invention.

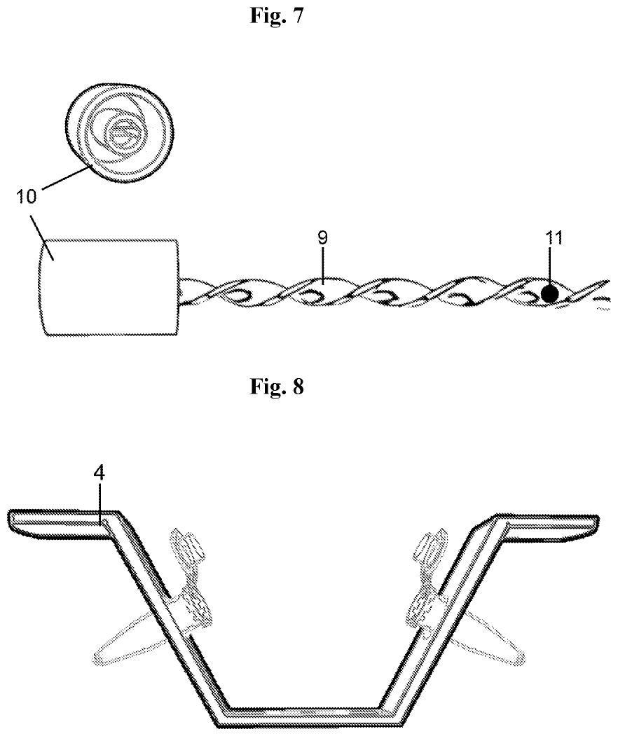

As depicted in FIG. 7, the helical rod (9) has a handle (10) affixed to one end. The user holds onto this handle to move the helical rod (9) up and down in order to impart rotational motion to the centrifuge assembly via the clutch. The other end of the helical rod (9) has a protrusion, in this case a small disk (11) affixed at the end to keep the rod after the device is fully assembled from passing through the radial disk (2) when the helical rod (9) is pulled up, thus limiting the upward travel of the helical rod (9) as a user pumps (pushes and pulls) on the handle (10) to accelerate and/or maintain rotation of the centrifuge assembly.

One embodiment of the insert (or adapter or rotor) (4) that houses scientific samples in microfuge tubes is shown in FIGS. 1, 2, 8, and 9. FIGS. 1 and 2 show how the insert (or adapter or rotor) (4) fits in this embodiment of the invention and FIG. 8 shows a close-up that accommodates two 1.5 ml microcentrifuge tubes across from each other. The insert (or adapter or rotor) (4) has a hole in the middle of it that allows it to pass over the spindle rod (3) and into the bowl (5) where it is affixed. The spindle rod (3) serves as an alignment rod for the insert (or adapter or rotor) (4) to ensure the final device is balanced and spins uninterrupted. This is one embodiment of the insert (or adapter or rotor) (4). The insert may be modified to accommodate more than two test tubes and the device modified to accommodate larger sample tubes and plates.

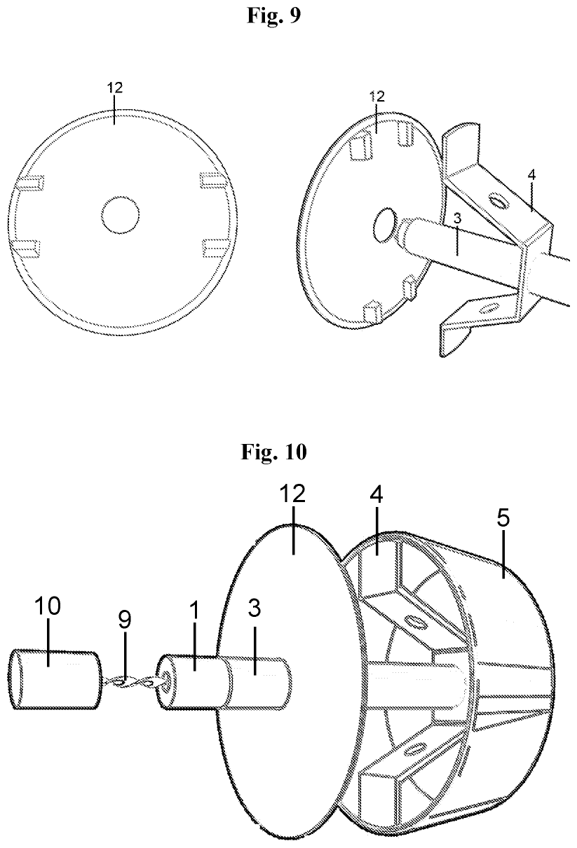

In one embodiment of the invention, there is an optional safety lid (12), as shown in FIG. 9. This lid is not required for operation of the device but for the safety of the user. The handle (10), clutch lid (1) and spindle rod (3) are all the same diameter in this embodiment. This allows the safety lid (12) to be taken on and off the device via a hole in the center of the safety lid (12). There are four protrusions on the safety lid (12) that match the size of the insert (or adapter or rotor) (4) and keep the lid secure when the device is spinning.

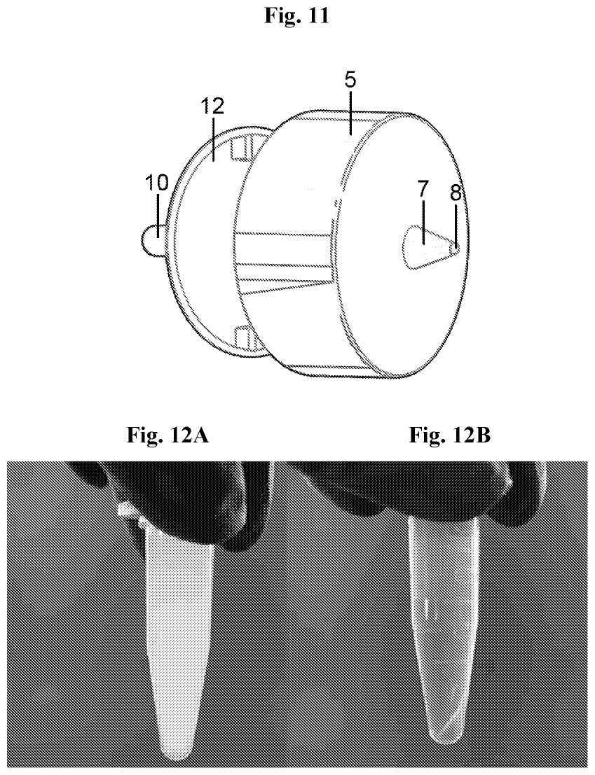

FIGS. 10 and 11 depict a fully assembled embodiment of the invention. In FIG. 10, the handle (10) is affixed to the helical rod (9) and inserted through the clutch assembly, which includes a clutch lid (1), a radial disk (2), and the top of the spindle rod (3). In the embodiment shown in FIGS. 10 and 11, the radial disk (2) is enclosed in the clutch lid (1) and is not visible. The radial disk (2) is free to move within the clutch assembly in conjunction with the helical rod's (9) reciprocating motion. When the handle (10) is pulled upward, the radial disk (2) moves away from the top of the spindle rod (3) so that the “bumps” on the bottom of the radial disk (2) and top of the spindle rod (3) disengage. When the helical rod (9) is pushed down the helical twist exerts enough pressure to lock the radial disk (2) and the top of the spindle rod (3) together, converting the helical rod's screwing action into rotation of the centrifuge assembly. The lid of the device (12) is shown partially open, which permits placing samples into the insert (4) (or adapter or rotor). The spindle rod (3) is affixed to (or integrated with) the bottom of the bowl (5) and the insert (4) (or adapter or rotor) is affixed to the spindle rod (3) so that it is positioned inside of the bowl (5). The spinner mechanism (7-8) is depicted in FIG. 11 affixed to the bowl (5), with the glass bead (bearing) (8) affixed to the cone (7). When the device is assembled, the alignment rod (6) is no longer visible and remains within the device, further reinforcing it and maintaining alignment.

One embodiment of using this invention is the separation of solid from a liquid suspension or separation of liquids of different density. In either case, the sample is placed in two test tubes (or in one tube with the other tube containing a substantially equivalent mass so as to balance the sample-containing tube). The two tubes are filled with approximately the same amount of sample and are placed in the two openings in the insert (or adapter or rotor) (4). In this embodiment, the test tubes do not have to be exactly the same weight for the centrifugal device to spin evenly. In another case, the sample may be placed in one test tube and the other test tube filled with the same amount of any liquid (or a substantially equivalent mass) to provide even spinning. After the samples are placed in the tubes and the tubes placed in the insert (or adapter or rotor) (4), the lid (12) is placed on the device and it is spun by pumping the handle (10) up and down moving the helical rod (9) through the clutch (FIG. 6). This movement rotates the spindle rod (3) affixed to the bowl (5), resulting in the bowl spinning. The cone (7) affixed to the bottom of the bowl (5) spins on a surface with the glass bead (8) in contact with the surface. In this embodiment, the glass bead minimizes friction between the cone and the surface, resulting in faster spinning and longer spin time. The insert (4) (or adapter or rotor) is affixed to the spindle rod (3) disk and also rotates at the same rate as the bowl (5) and spindle rod (3).

This embodiment of the device is calculated to exert a centrifugal force of approximately 140 times the force of gravity (140×g) on the samples, although the invention can be readily adapted to achieve a higher or lower g-forces. In the present representative example, the centrifugal force was calculated using a slow motion camera with the lid (12) of the device removed. One side of the insert (4) (or adapter or rotor) was marked and the number of times the mark rotated per minute was recorded. The rotations per minute and radius of the insert (or adapter or rotor)/bowl (4,5) in centimeters was used to calculate the g-force using the following equation: G-Force=0.00001118×Rotor Radius×(RPM)². Varying the rotational speed and the radius of the insert (or adapter or rotor) (4), for example, by using a different insert that places the sample-containing tubes farther from or nearer the spindle rod (3) or a larger chamber or bowl to accommodate a larger insert or adapter or rotor) (4), are parameters that can be varied in different embodiments in order to achieve higher or lower g-force (or range of g-forces), allowing different experiments to be performed. Some embodiments of the invention envision providing inserts (or adapters or rotors, be they permanently attached to the bowl or removable) (4) having different radii and allowing more than one sample-containing tube to be loaded per arm (or region) of the insert that can be changed, increasing the range of potential experiments that can be performed and numbers of samples that can be centrifuged in single run. For example, the invention can readily be adapted to provide manually powered centrifuges capable of generating less than 20 to more than 1,000, 2,000, 3,000, or more g's. In some embodiments, the rotable assembly includes one or more weights added, preferably about the periphery of the assembly, to increase momentum of the assemble as it rotates (and force as it accelerates).

The embodiment depicted in the Figures can spin for approximately 1-2 minutes after pumping has stopped, depending on the smoothness of the surface and how evenly and quickly the device was pumped. This force is safe and appropriate for an educational tool and is sufficient for a typical educational experiment even through high school and possibly community college. For example, in advanced high school experiments, protein precipitates have been separated from a liquid suspension after spinning in the device for 2 minutes. FIG. 12 shows a specific example where the protein trypsin was precipitated from homogenized bovine pancreas using trichloroacetic acid. In FIG. 12A, the precipitate was distributed throughout the solution before centrifugation with the device and in FIG. 12B the precipitated enzyme is tightly packed at the bottom of the microcentrifuge tube after centrifugation. As already described, and as those in the art will appreciate based on this specification, the centrifugal force and duration of the spin can be changed through modification of the geometry and weight of the device.

The embodiment depicted in FIGS. 1-12 was largely produced by 3D printing. For parts 3-7, polylactic acid (PLA) polymer was used. This polymer yields rigid parts that are strong enough to withstand use by children. Parts 1-2, and 12 were produced with polyethylene terephthalate glycol (PETG) polymer. This polymer yields much stronger parts. When part 2, the radial clutch, was produced with PLA filament, it was found to degrade over time due to the repeated friction of the helical rod (9) passing through its slit. Part 1 was also prepared from PETG to ensure maximal stability to long-term wear and tear from the helical rod (9). The lid (12) was produced from PETG because PETG also yields slightly more flexible parts making it easier to remove the lid from the device than its stiffer PLA counterpart. The device components can also be produced using other methods and polymers, for example, injection molding.

The helical rod (9) was prepared by twisting ¼ inch aluminum flat rod that was 1/16 of an inch thick. Rod was twisted by placing one end in a vice. A hollow tube was prepared through 3D printing to fit over the rod and keep it straight during the twisting process. The tube was held in place with a clamp attached to a stationary stand. The other end of the flat rod was clamped with vice grips that were rotated perpendicular to the axis of the rod. In this embodiment, the helical rod (9) was rotated to yield a twisting rate of approximately 1.5 cm per turn. As will be appreciated, other twist rates (with greater or lesser amounts of twist per unit distance) are envisioned and within the scope of the invention. The handle (10) fits securely on the top of the twisted rod and a small disk (11) the radius of the alignment rod (6) was affixed to the other end of the helical rod after it was passed through the clutch mechanism.

The device is assembled as described above, and in this embodiment, the components are affixed with cyanoacrylate glue. Specifically, the glass bead (bearing) (8) is affixed in the spinner cone (7). The alignment rod (6) is affixed to the assembled spinner (7,8). The spinner assembly (7,8) is affixed to the bowl (5) guided by the alignment rod (6) that protrudes into the bowl by approximately 1 cm. Next, the spindle rod (3) is affixed to the inside of the bowl (5) through the disk at its end (3) and aligned in the bowl (5) guided by the alignment rod (6). The insert (4) is passed over the spindle rod (3) and affixed to the spindle rod disk (with the cyanoacrylate glue) that has already been affixed to the bowl (5). Permanent affixation of the insert (4) to the spindle rod disk (3) is not required. The insert may be held in place through other mechanisms that would allow it to be removed and replaced with other embodiments of the insert. In other embodiments multiple inserts of different geometries may be prepared to house different numbers of samples or different sample sizes. In this embodiment, the insert is affixed as a safety precaution. In other embodiments, the insert (4) and other embodiments of the insert maybe affixed to the spinner assembly (7,8) without the bowl (5). In the embodiment shown in the Figures, the bowl (5) stabilizes the unit and protects the user from potential injury from the insert (4), samples, etc. during operation. The helical rod (9) is inserted through the clutch's radial disk (2) and the handle (10) is affixed at one end and the disk (11) affixed at or near the other end of the helical rod (9). This helical rod assembly is inserted into the spindle rod (3). The lid (1) of the clutch mechanism is affixed to the spindle rod (3), allowing the enclosed radial disk (2) to move between engaged and disengaged positions with the top of the spindle rod (3). At this point, the device is assembled. It can then be placed on a surface and the insert (4) spun by moving the helical rod assembly up and down using pumping motion after grasping the handle. The device may be continually pumped or pumped and then allowed to spin freely to achieve the ideal results for the specific separation.

The manually powered centrifuges of the invention can be used for any suitable purpose analytical, commercial, educational, industrial, or research purpose, including separating mixtures of solutions having different densities, separating immiscible liquids, separating suspended particles, solids, etc. from solution, separating blood components, separating insoluble particles or other components suspended in solution, etc.

Unless the context clearly requires otherwise, throughout the description above and the appended claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list, and any combination of the items in the list.

The foregoing description, for purpose of explanation, has been described with reference to specific embodiments. However, the illustrative discussions above are not intended to be exhaustive or to limit the invention to the precise forms disclosed. Many modifications and variations are possible in view of the above descriptions. The embodiments were chosen and described in order to best explain the principles of the invention and its practical applications to thereby enable others skilled in the art to best utilize the invention and various embodiments with various modifications as are suited to the particular use contemplated. As such, the invention extends to all functionally equivalent structures, methods, and uses, such as are within the scope of the appended claims, and it is intended that the invention be limited only to the extent required by the applicable rules of law.

1. A manually powered centrifuge, comprising a manually powered drive system connected via a clutch to a rotable assembly that includes an attached or removable insert configured for placement of samples, or tubes containing samples, for centrifugation.

2. A method of sample centrifugation, comprising using a centrifuge according to claim 1 to centrifuge a sample in a tube loaded into the rotable assembly.
